(19) United States
(12) Patent Application Publication
(10) Pub. No.: US 2025/0261018 A1
(43) Pub. Date: Aug. 14, 2025

(54) METHOD AND DEVICE FOR LEARNING-BASED JOINT FRAMEWORK FOR CHANNEL STATE INFORMATION (CSI) COMPRESSION AND PREDICTION

(71) Applicant: Samsung Electronics Co., Ltd., Gyeonggi-do (KR)

(72) Inventors: Jin Hyun SO, San Diego, CA (US); Hyuk Joon KWON, San Diego, CA (US)

(21) Appl. No.: 18/769,761

(22) Filed: Jul. 11, 2024

Related U.S. Application Data
(60) Provisional application No. 63/553,338, filed on Feb. 14, 2024.

(51) Int. Cl. H04W 24/10

(52) U.S. Cl. CPC H04W 24/10

(57) ABSTRACT

A method and device are provided in which an encoder of a user equipment (UE) compresses channel vectors of a channel state information (CSI) matrix to generate respective compressed vectors, and a processor of the UE generates a predicted channel vector by performing machine learning (ML)-based CSI prediction on the compressed vectors. The UE reports a predicted CSI.to a base station (BS) based on the predicted channel vector.

### CROSS-REFERENCE TO RELATED APPLICATION

This application claims the priority benefit under 35 U.S.C. § 119 (e) of U.S. Provisional Application No. 63/553,338, filed on Feb. 14, 2024, the disclosure of which is incorporated by reference in its entirety as if fully set forth herein.

### TECHNICAL FIELD

The disclosure generally relates to channel state information (CSI) feedback in a wireless communication system. More particularly, the subject matter disclosed herein relates to improvements to machine-learning (ML)-based CSI prediction techniques at a user equipment (UE).

### SUMMARY

In a massive multiple-input multiple-output (MIMO) system, the reception of real-time CSI at a base station (BS) plays an important role in exploiting benefits of enhanced MIMO techniques. However, existing challenges for CSI feedback may include substantial uplink bandwidth (i.e., feedback overhead), low reconstruction accuracy at the BS, and channel aging.

In medium and high UE mobility conditions, a channel response that is estimated by a UE and a channel of a practical physical downlink shared channel (PDSCH) transmission may be mismatched by the BS due to movement of the UE, which may be referred to as channel aging. In a high speed UE scenario, channel aging may seriously affect downlink transmission performance, even when the downlink CSI is properly fed back to the BS by the UE.

CSI prediction may be utilized to mitigate the channel aging problem. For example, the BS or the UE may utilize previous channel observations (or CSI-reference signal (RS) estimation results) to predict a future CSI in order to reduce the impact of processing and feedback delays.

Attempts have been made to perform CSI prediction using analytical techniques such as auto-regression and polynomial extrapolation. However, such techniques rely on channel models and may not reflect the complexity of channel evolution.

To solve this problem, ML-based CSI prediction has emerged as a powerful solution.

One issue with the above approach is that for both analytical and ML-based solutions, a major bottleneck in implementing CSI prediction in a UE is the complexity of hardware (HW) that is required to store past observations. For example, a UE that supports 3rd Generation Partnership Project (3GPP) Release (Rel.) 17 maintains CSI-RS channel estimation results with a dimensionality of up to 273 resource blocks×32 transmit ports×four receive antennas for a single time stamp. In 3GPP Rel. 18, the UE may need to maintain multiple CSI observations over time for CSI prediction, which requires a buffer size that is too large to be implemented in the UE due to the limited HW resources.

To overcome these issues, systems and methods are described herein for an ML-based joint framework of CSI compression and CSI prediction. The above approaches improve on previous methods because they significantly reduce HW complexity while preserving the prediction performance.

In an embodiment, a method is provided in which an encoder of a UE compresses channel vectors of a CSI matrix to generate respective compressed vectors, and a processor of the UE generates a predicted channel vector by performing ML-based CSI prediction on the compressed vectors. The UE reports a predicted CSI.to a BS based on the predicted channel vector.

In an embodiment, a UE is provided that includes an encoder that compresses channel vectors of a CSI matrix to generate respective compressed vectors, and a processor that generates a predicted channel vector by performing ML-based CSI prediction on the compressed vectors and reports a predicted CSI.to a BS based on the predicted channel vector.

In an embodiment, a UE is provided that includes a processor and a non-transitory computer readable storage medium storing instructions. When executed, the instructions cause the processor to compress channel vectors of a CSI matrix to generate respective compressed vectors, generate a predicted channel vector by performing ML-based CSI prediction on the compressed vectors, and report a predicted CSI.to a base station (BS) based on the predicted channel vector.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating signal timing of a BS and a UE for CSI prediction;

FIG. 2 is a diagram illustrating ML-based CSI prediction without compression;

FIG. 3 is a diagram illustrating a joint framework of CSI compression and prediction, according to an embodiment;

FIG. 4 is a diagram illustrating a joint framework with a combined block for prediction and decoding, according to an embodiment;

FIG. 5 is a flowchart illustrating a method for generating a precited CSI, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Embodiments described herein provide a method in which a UE provides an improved trade-off between CSI prediction performance and HW complexity. More specifically, CSI prediction is performed in latent space (e.g., space of dimensionality reduction or data compression) to significantly reduce HW complexity in terms of buffer size to store past observations, while a joint ML block for CSI prediction and decompression and a task-aware categorizing of ML blocks significantly reduce HW complexity in terms of the number of ML model parameters required (i.e., storage complexity).

In a massive MIMO orthogonal frequency division multiplexing (OFDM) system, a single user (i.e., a UE) and a single BS may have NUE data streams and NBs data streams, respectively.

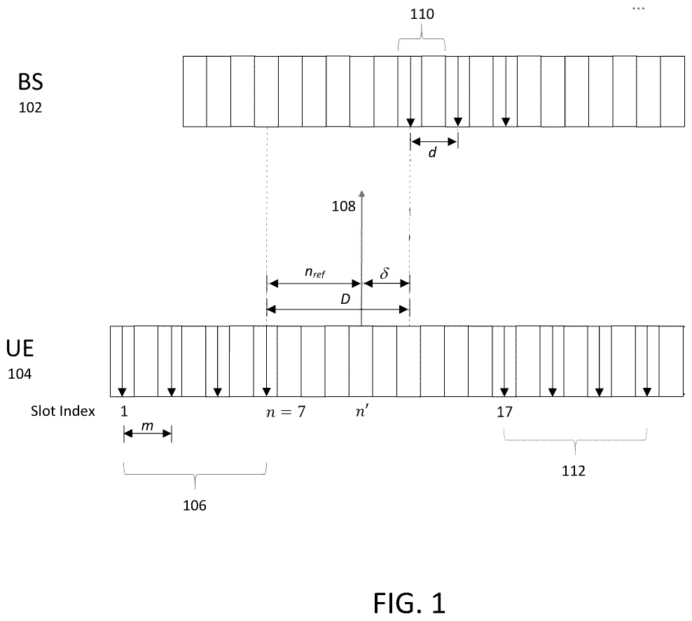

FIG. 1 is a diagram illustrating signal timing of a BS and a UE for CSI prediction. A BS 102 may send an OFDM transmission with N data streams to a UE 104 over K sub-carriers (e.g., access point (AP)-CSI-RS resources 106). A received signal on a k-th subcarrier may be expressed as shown in Equation (1) below.

$${y}_{k} ( n ) = {H}_{k}^{H} ( n ) {V}_{k} ( n ) {x}_{k} ( n ) + {w}_{k} ( n ) \qquad ( 1 )$$

In Equation (1), Hₖ(n) ∈ [symbol] ^{N}^{_{BS}}^{×N}^{_{UE}}, Vₖ(n) ∈ [symbol] ^{N}^{_{BS}}^{×N}^{ₛ}, Xₖ(n) ∈ [symbol] ^{N}^{ₛ}, Wₖ(n) ∈ [symbol] ^{N}^{_{UE}} denote a channel matrix in a frequency domain, a precoding matrix at the BS, a downlink transmitted data symbol, and additive white Gaussian noise on a k-th subcarrier, respectively, at time stamp n. Although n represents a slot index herein, n may represent any suitable time unit.

H(n)={real({H₁(n), H₂(n), . . . , H_{K}(n)}), imag({H₁(n), H₂(n), . . . , H_{K}(n)})}∈ [symbol] ^{2×K×N}^{_{BS}}^{×N}^{_{UE}} is a tensor representing an entire CSI stacked by the channel matrices on all subcarriers, while real(·) and imag(·) denote the real and imaginary part of the input, respectively.

Resolution in a frequency dimension may vary according to the granularity of AI-based CSI feedback, as defined by 3GPP, and herein, a resource block (RB) is used.

Key parameters used in CSI prediction are defined in Table 1 below.

TABLE 1

| Category | Variable | Definition |
|---|---|---|
| CSI-RS resources | K | number of AP-CSI-RS resources for a |
| | | channel management resource (CMR) |
| | m | offset between two AP-CSI-RS |
| | | resources for the CMR |
| Prediction | D | feedback delay n_{ref} + operation delay δ |
| parameters | N₄ | number of predicted CSI |
| | d | offset between two adjacent predicted |
| | | CSI |

A goal of the UE 104 is to predict future channel tensors based on past p observations of the AP-CSI-RS resources 106 with an m offset up to the time n (i.e., {H(n−m(p−1)), . . . , H(n−m), H(n)}). Specifically, with respect to FIG. 1, the AP-CSI-RS resources 106 are received at slot indices 1, 3, 5, and 7, where n=7. As shown in FIG. 1, the UE 104 may predict and report CSI with multiple time stamps 108. The UE 104 reports the predicted CSI 108 to the BS 102 at slot index n′ after a feedback delay n_{ref} from the last observation at slot index n. Herein, for simplicity, a single future channel matrix 110 may be predicted for time n+D (i.e., N₄=1)) with an offset d=1, while leaving the extension to a generalized case. The methodology may then repeat for a next burst 112 of AP-CSI-RS resources received beginning at slot index 17.

The UE may design a prediction function lₚ: { [symbol] ^{2×K×N}^{_{BS}}^{×N}^{_{UE}}}^{P}→ [symbol] ^{2×K×N}^{_{BS}}^{×N}^{_{UE}} to predict a future channel tensor, which may be represented as Equation (2) below.

$$\hat{H} ( n + D ) = {l}_{ρ} ( H ( n - p + 1 ) , … , H ( n - 1 ) , H ( n ) ) \qquad ( 2 )$$

In Equation (2), p denotes parameters for the prediction. However, storing all past p observations may be impractical due to the limited HW resources in the UE. Accordingly, a pre-processing function f_{ϕ}: [symbol] ^{2×K×N}^{_{BS}}^{×N}^{_{UE}}→ [symbol] ^{λ} and post-processing function g_{θ} may be designed such that Equation (3) is satisfied as set forth below.

$$\hat{H} ( n + D ) = {g}_{θ} ( {l}_{ρ} ( {f}_{ϕ} ( H ( n - p + 1 ) ) , … , {f}_{ϕ} ( H ( n - 1 ) ) , {f}_{ϕ} ( H ( n ) ) ) ) \qquad ( 3 )$$

In Equation (3), a prediction function is changed to lₚ: [symbol] P×λ→R^{λ}. Pre-processing function f_{ϕ} aims to reduce the dimensionality of CSI by a ratio of

$$\frac{λ}{2 \times K \times {N}_{BS} \times {N}_{UE}}$$

and the UE stores f_{ϕ}(H) instead of H, which can significantly reduce the storage complexity. θ, p, ϕ may be jointly designed to minimize prediction loss, which may be expressed by Equation (4) below.

$${ϕ}_{λ}^{opt} , {ρ}_{λ}^{opt} , {θ}_{λ}^{opt} = arg {min}_{ϕ , ρ , θ} {𝔼}_{H} [ L ( H ( n + D ) , {g}_{θ} ( {l}_{ρ} ( {f}_{ϕ} ( H ( n - p + 1 ) ) , … , {f}_{ϕ} ( H ( n ) ) ) ) ) ] \qquad ( 4 )$$

ML-based CSI prediction may be performed with limited HW resources of the UE.

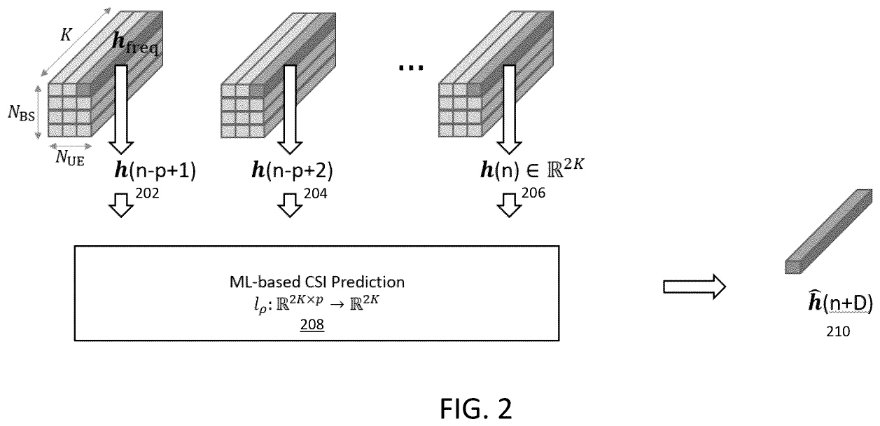

FIG. 2 is a diagram illustrating ML-based CSI prediction without compression. More specifically, FIG. 2 illustrates a naïve ML-based architecture used to predict future CSI, where prediction is performed in a channel domain.

Individual channel vectors 202, 204, and 206 may be stored in a buffer. Specifically, the CSI matrix H(n) ∈ [symbol] ^{2×K×N}^{_{BS}}^{×N}^{_{UE}}, where n is a time stamp (e.g., slot index in LTE/NR), may be partitioned into vectors h^{part}(n) ∈ [symbol] ^{2×K×1×1} such that each part has a single element in the BS antenna and UE antenna dimensions. Prediction may be carried out at an ML-based CSI prediction block 208, which outputs a future channel vector h (n+D) or predicted CSI 210.

However, the past p CSI observations, {H(n−p+1), . . . , H(n)} ∈ [symbol] ^{p×K×N}^{_{BS}}^{×N}^{_{UE}} may have a dimensionality of up to [symbol] ^{4×273×32×4}, which is impractical to be stored in a UE due to the limited HW resources.

In addition to a large buffer size, this architecture may require a significant number of ML parameters.

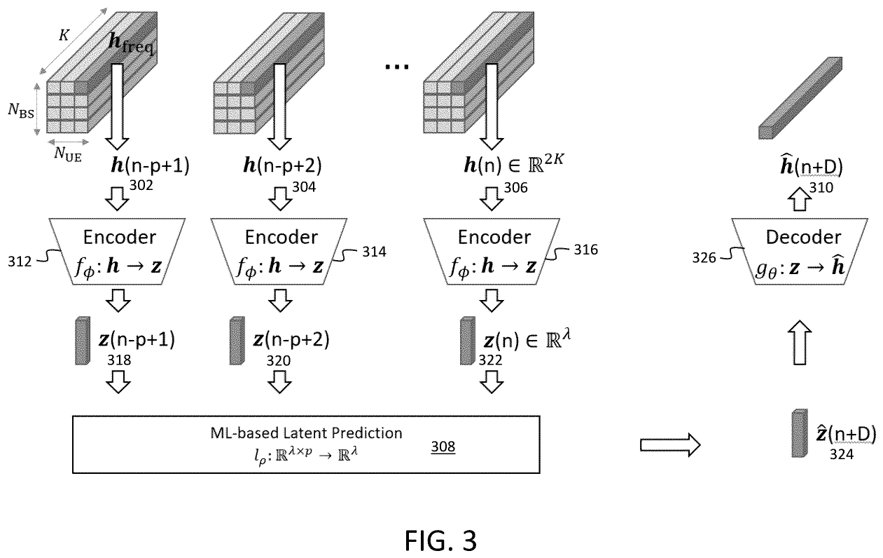

FIG. 3 is a diagram illustrating a joint framework of CSI compression and prediction, according to an embodiment.

In order to provide a prediction in latent space, auto-encoder (AE)-based CSI compression and ML-based CSI prediction may be jointly designed, which allows for prediction in a compressed domain (i.e., latent space) while preserving prediction performance.

Compression may be applied to individual channel vectors 302, 304, and 306 at encoders 312, 314, and 316, respectively, prior to prediction, and resulting compressed latent vectors 318, 320, and 322 are stored in a buffer, allowing for significantly reduced required buffer size. Specifically, the CSI matrix H(n) ∈ [symbol] ^{2×K×N}^{_{BS}}^{×N}^{_{UE}}, where n is a time stamp (e.g., slot index in LTE/NR), may be partitioned into vectors h^{part}(n) ∈ [symbol] ^{2×K×1×1} such that each part has a single element in the BS antenna and UE antenna dimensions. The partitioned vector may be compressed by an encoder of the AE into a latent vector z(n) ∈ [symbol] ^{λ} such that the dimension of the latent vector is much smaller than the original channel vector. The latent vectors may be stored in a buffer over multiple time stamps to predict future channel information. The UE may significantly save on the storage complexity of the buffer as the size of the latent vector is much smaller than the size of the original channel vectors (i.e., λ><2K).

Prediction may be carried out in the latent space at an ML-based latent prediction block 308, which outputs a latent representation of the future CSI 324. Specifically, by utilizing p past latent vectors z(n−p+1), . . . , z(n), 318, 320, and 322, the ML-based latent prediction block may output the future latent vector z(n+D) 324, where D is a prediction length.

A decoder 326 of the AE may decompresses the future latent vector 324 into a future channel vector h(n+D) or a predicted CSI 310.

Accordingly, in addition to the buffer size reduction, the architecture described above may significantly reduce the number of ML parameters, which saves on storage complexity and inference time. For example, a single (and the same) encoder may be applied to channel vectors with different time stamps for CSI compression. Additionally, dimensionality of the latent space may be considerably smaller than the dimensionality of the original channel matrix. As prediction is performed in the latent space, the number of ML parameters for the prediction may be significantly reduced.

Separate training and joint training may be considered for the joint framework of CSI compression and prediction. The training methods are shown in Table 3 below.

TABLE 3

| Separate training (Naive approach) | Joint training |
|---|---|
| 1) Train AE pair: ϕ*, θ* | Jointly train ϕ*, θ*, ρ* |
| ϕ*, θ* = argmin [symbol] \|h − g_{θ}(f_{ϕ}(h)\| | ϕ*, θ*, ρ* = argmin [symbol] \|h_{n+D} − g_{θ}(\hat{z}_{n+D})\| |
| 2) Generate latent vector dataset by using ϕ*, | where \hat{z}_{n+D} = ρ (f_{ϕ}(hₙ₋ₚ₊₁), ..., f_{ϕ}(hₙ)) |
| - sample pair: | |
| {zₙ₋ₚ₊₁, ..., zₙ; z_{n+D}} | |
| 3) Train a predictor: ρ* | |
| ρ* = argmin [symbol] \|z(n + D) | |
| − l_{ρ}(z(n − p + 1), ..., z(n))\| | |

Joint training may significantly improve prediction performance of the proposed joint framework. For example, when a latent size is 16, the buffer size may be reduced with a ratio of

$$\frac{λ}{2 K} = \frac{16}{2 * 128} = \frac{1}{16}$$

while performance degradation is small (e.g., less than 0.25 dB in NMSE).

In order to further reduce HW complexity, ML blocks of prediction in latent space and decoding may be combined.

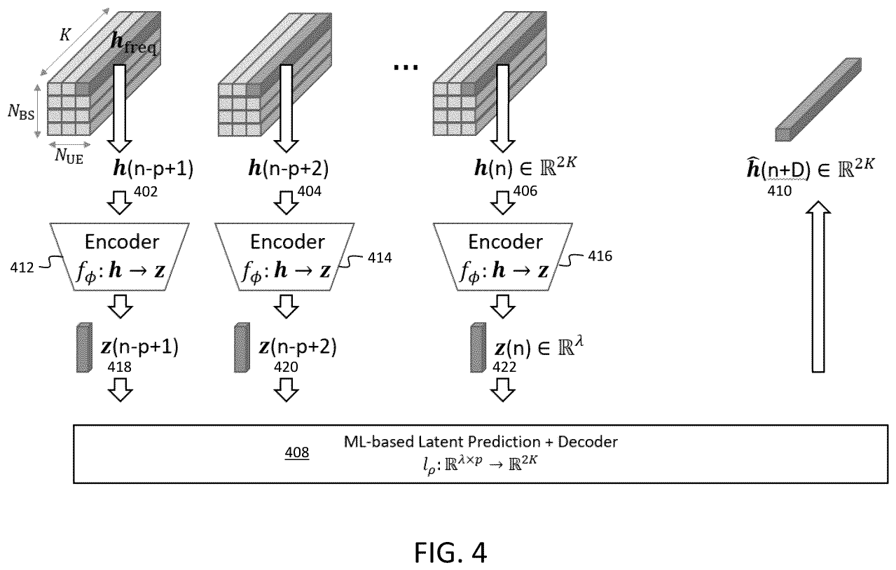

FIG. 4 is a diagram illustrating a joint framework with a combined block for prediction and decoding, according to an embodiment.

Compression may be applied to individual channel vectors 402, 404, and 406 at encoders 412, 414, and 416, respectively, prior to prediction, and resulting compressed latent vectors 418, 420, and 422 may be stored in a buffer, enabling a significantly reduced required buffer size. Specifically, the CSI matrix H (n) ∈ [symbol] ^{2×K×N}^{_{BS}}^{×N}^{_{UE}}, where n is time stamp (e.g., slot index in LTE/NR), may be partitioned into vectors h^{part}(n) ∈ [symbol] ^{2×K×1×1} 402, 404, and 406 such that each part has a single element in the BS antenna and UE antenna dimensions. A partitioned vector may be compressed by an encoder of an AE into a latent vector z (n) ∈ [symbol] ^{λ} such that the dimension of the latent vector is much smaller than the original channel vector. The latent vectors 418, 420, 422 may be stored in a buffer over multiple time stamps to predict future channel information. The UE may significantly save on the storage complexity of the buffer as the size of the latent vector is much smaller than the size of the original channel vectors (i.e., λ<<2K).

ML-based prediction and decoding may be carried out in the latent space at an ML-based latent prediction and decoder block 408, which outputs a future channel vector h(n+D) or a predicted CSI 410.

As illustrated in FIG. 4, the number of ML parameters may be further reduced by combining prediction and decoding into a single block. Approximately 2k ML parameters may be saved for prediction and decoding by combing the blocks.

NMSE performance of the new framework may be further evaluated with the combined block. The combined block not only reduces the number of ML parameters but also improves the prediction performance.

As described above, a new joint framework is provided for CSI compression and CSI prediction that can significantly reduce HW complexity while preserving prediction performance. Although the embodiments described above are directed to a case in which the number of predicted CSI is one and an offset between CSI-RS measurements is fixed, embodiments may extend to generalized parameters, {p, d, m, N₄} and categorizing multiple ML models to support various channel profile, Doppler, and signal-to-noise ratio (SNR) ranges.

According to an embodiment, a different ML model may be trained for each channel profile. In this case, the number of ML models may be linear to the number of channel profiles to be supported. Categorizing different environments into some groups may reduce the number of ML models while preserving the prediction performance. Compression and prediction models may be categorized with channel delay profile and Doppler, respectively. With an architecture having joint compression and prediction, it may be beneficial to categorize the ML models to provide a tradeoff between performance and HW complexity.

Specifically, task-aware categorizing of ML blocks aims to support various channel environments with limited HW resources to store various ML models in the UE. For each block, the UE categorizes ML models with a different categorization methodology depending on the task of the block. This feature can save HW complexity to store multiple ML parameters.

To support various channel environments (e.g., SNR, delay profile, Doppler, etc.), the UE may support multiple ML models for each block (e.g., encoder, decoder, prediction). For example, the UE may train and maintain three encoder models ϕ₁, ϕ₂, and ϕ₃ for short/mid/long delay profiles, respectively.

As each block has a different task (compression or prediction), and a different categorization method for multiple ML models can be applied to each block. Each task has different important features. For example, delay profile is important to an AE (encoder and decoder) that aims to compress and decompress, while Doppler is important to the prediction block.

Assuming J and K are sets of ML model indices for delay profile and Doppler, respectively, by applying task-aware categorization of ML models, the number of ML models can be reduced from [symbol] to [symbol] and [symbol] where ϕ, θ, and ρ represent ML models for an encoder, a decoder, and prediction, respectively.

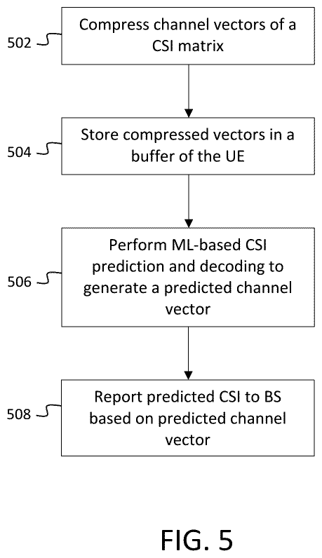

FIG. 5 is a flowchart illustrating a method for generating a precited CSI, according to an embodiment. At 502, an encoder of a UE may compress received channel vectors of a CSI matrix to generate compressed vectors. The CSI matrix may be partitioned into the channel vectors. The dimensions of the compressed vectors are less than the dimensions of the channel vectors. The encoder may be part of an AE.

At 504, the UE may store the compressed vector in a buffer of the UE over multiple time stamps.

At 506, a processor of the UE may generate a predicted channel vector by performing ML-based CSI prediction on the compressed vector. The predicted channel vector may be generated in two steps by performing ML-based CSI prediction using the compressed vector to generate a latent representation of the predicted channel vector, and then decompressing, by a decoder of the UE, the latent representation to generate the predicted channel vector. Alternatively, the predicted channel vector may be generated in a single step by performing ML-based CSI predication and decoding on the compressed vector to generate the predicated channel vector.

Compressing the channel vector, performing ML-based CSI prediction, and decompressing the latent representation may be performed with task-dependent ML models. For example, compressing the channel vector and decompressing the latent representation may include selecting a first ML model from a first set of ML models for encoding and decoding, and performing ML-based CSI predication may include selecting a second ML model from a first set of ML models for CSI prediction.

At 508, the UE may report a predicted CSI.to a BS based on the predicted channel vector. As described above with respect to FIG. 1, the UE reports the predicted CSI to the BS after a feedback delay from a last observation. Using the predicted CSI, the BS may predict a future channel matrix.

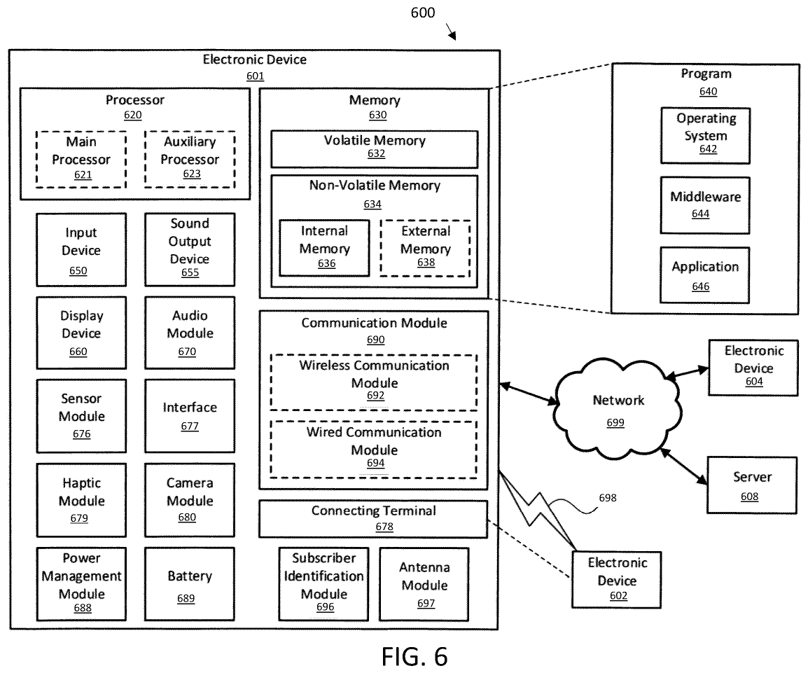

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
compressing, by an encoder of a user equipment (UE), channel vectors of a channel state information (CSI) matrix to generate respective compressed vectors;
generating, by a processor of the UE, a predicted channel vector by performing machine learning (ML)-based CSI prediction on the compressed vectors; and
report, by the UE, a predicted CSI to a base station (BS) based on the predicted channel vector.

2. The method of claim 1, wherein the encoder comprises an auto-encoder of the UE.

3. The method of claim 1, wherein each compressed vector has a smaller number of dimensions than a corresponding channel vector.

4. The method of claim 1, the CSI matrix is partitioned into the channel vectors.

5. The method of claim 1, further comprising storing the compressed vectors in a buffer of the UE.

6. The method of claim 5, wherein the compressed vectors are stored in the buffer over multiple time stamps.

7. The method of claim 1, wherein generating the predicted channel vector comprises:
performing, by the processor, ML-based CSI prediction using the compressed vectors to generate a latent representation of the predicted channel vector; and
decompressing, by a decoder of the UE, the latent representation to generate the predicted channel vector.

8. The method of claim 1, wherein generating the predicted channel vector comprises:
performing, by the processor, ML-based CSI prediction and decoding on the compressed vectors to generate the predicted channel vector.

9. The method of claim 8, wherein compressing the channel vectors comprises selecting a first ML model from a first set of ML models for encoding and decoding, and performing ML-based CSI prediction comprises selecting a second ML model from a second set of ML models for CSI prediction.

10. The method of claim 1, wherein compressing the channel vectors and performing ML-based CSI prediction are performed with task-dependent ML models.

11. A user equipment (UE) comprising:
an encoder configured to compress channel vectors of a channel state information (CSI) matrix to generate respective compressed vectors; and
a processor configured to generate a predicted channel vector by performing machine learning (ML)-based CSI prediction on the compressed vectors, and report a predicted CSI to a base station (BS) based on the predicted channel vector.

12. The UE of claim 11, wherein the encoder comprises an auto-encoder of the UE.

13. The UE of claim 11, wherein each compressed vector has a smaller number of dimensions than a corresponding channel vector.

14. The UE of claim 11, further comprising a buffer configured to store the compressed vectors.

15. The UE of claim 14, wherein the compressed vectors are stored in the buffer over multiple time stamps.

16. The UE of claim 11, further comprising a decoder, wherein:
in generating the predicted channel vector, the processor is configured to perform ML-based CSI prediction using the compressed vectors to generate a latent representation of the predicted channel vector; and
in generating the predicted channel vector, the decoder is configured to decompress the latent representation to generate the predicted channel vector.

17. The UE of claim 11, wherein, in generating the predicted channel vector, the processor is configured to:
perform ML-based CSI prediction and decoding on the compressed vectors to generate the predicted channel vector.

18. The UE of claim 17, wherein, in compressing the channel vectors, the processor is configured to select a first ML model from a first set of ML models for encoding and decoding, and, in performing ML-based CSI prediction, the processor is configured to select a second ML model from a second set of ML models for CSI prediction.

19. The UE of claim 11, wherein compressing the channel vectors and performing ML-based CSI prediction are performed with task-dependent ML models.

20. A user equipment (UE) comprising:
a processor; and
a non-transitory computer readable storage medium storing instructions that, when executed, cause the processor to:
compress channel vectors of a channel state information (CSI) matrix to generate respective compressed vectors;
generate a predicted channel vector by performing machine learning (ML)-based CSI prediction on the compressed vectors; and
report a predicted CSI to a base station (BS) based on the predicted channel vector.
